(19) United States
(12) Patent Application Publication
(10) Pub. No.: US 2024/0320493 A1
(43) Pub. Date: Sep. 26, 2024

(54) Improved Two-Stage Machine Learning for Imbalanced Datasets

(71) Applicants: Ahmet ISCEN, Paris (FR); Andre Filgueiras de Araujo, Mountain View, CA (US); Boqing Gong, Mountain View, CA (US); Cordelia Luise SCHMID, Paris (FR); Google LLC, Mountain View, CA (US)

(72) Inventors: Ahmet Iscen, Grenoble (FR); Andre Filgueiras de Araujo, Mountain View, CA (US); Boqing Gong, Bellevue, WA (US); Cordelia Luise Schmid, Saint Ismier (FR)

(21) Appl. No.: 18/254,634

(22) PCT Filed: Feb. 22, 2021
(86) PCT No.: PCT/US2021/019033

§ 371 Date: May 26, 2023

(51) Int. Cl. G06N 3/084

(52) U.S. Cl. CPC G06N 3/084

(57) ABSTRACT

Class-balanced distillation can train recognition models with little to no bias even if the training dataset has a class imbalance. A two stage training process with instance sampling and class-balanced sampling can train the recognition model to recognize both head classes and tail classes. Moreover, one or more teacher classification models can be trained, and the knowledge can be distilled to a student classification model.

### FIELD

The present disclosure relates generally to training machine-learned models such as, for example, object recognition models. More particularly, the present disclosure relates to improved two-stage learning for long-tailed training datasets which can include an instance sampling training stage and a distillation training stage with class-balanced sampling.

### BACKGROUND

Data on particular objects, samples, sounds, etc. can be limited by its occurrence in nature. For example, there are exponentially more images of a pigeon compared to images of a Galapagos tortoise. Imbalances such as this can cause skews in data, which can be referred to as a long-tailed distribution.

Imbalanced datasets (e.g., due to accessibility in the real world or in training data sample size) can cause biases in models trained on the imbalanced data (e.g., recognition models trained on class-imbalanced image datasets). Specifically, instance-based sampling—in which samples are chosen with equal probability regardless of class—can cause the model to become biased towards high sample size classifications. On the other hand, class-balanced sampling—in which samples are chosen so that each class has equal probability of selection—can cause an overfocus on the small sample sized classes.

Furthermore, models can become biased towards the initial sets of training data. The training of models on the same training dataset in the same training order can reinforce biases learned through building knowledge off the same initial data.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for improved machine learning on imbalanced datasets. The method can include obtaining, by a computing system including one or more computing devices, a training dataset with class imbalance. The method can include training, by the computing system, one or more teacher classification models with the training dataset using instance-based example selection. In some implementations, the method can include training, by the computing system, one or more student classification models with the training dataset using class-balanced example selection, and training can include training the one or more student classification models to predict data generated by the one or more teacher classification models via distillation training. The method can include providing, by the computing system, the one or more student classification models as an output.

In some implementations, each of the one or more teacher classification models can include a feature extraction portion configured to receive an input and generate a feature representation, and a classification portion configured to receive the feature representation and generate a classification output. In some implementations, each of the one or more student classification models can include a feature extraction portion configured to receive an input and generate a feature representation, and a classification portion configured to receive the feature representation and generate a classification output. Training the one or more student classification models to predict data generated by the one or more teacher classification models via distillation training can include training the feature extraction portion of the student classification model to predict the feature representation generated by the feature extraction portion of the one or more teacher classification models and training the classification portion of the student classification model to predict the classification output generated by the classification portion of the one or more teacher classification models. The one or more teacher classification models can include an ensemble of a plurality of teacher classification models respectively generated from a plurality of different initialization parameterizations. In some implementations, training, by the computing system, the plurality of teacher classification models with the training dataset using instance-based example selection can include using different initial random seeds of the training dataset for the plurality of teacher classification models. In some implementations, the one or more teacher classification model can include an ensemble of a plurality of teacher classification models that have a plurality of different sets of hyperparameters. The one or more teacher classification models can include an ensemble of a plurality of teacher classification models that have a same initial parameterization but are trained on different randomly-selected subsets of the training data. The one or more student classification models can include a convolutional neural network. Training, by the computing system, the one or more student classification models to predict data generated by the one or more teacher classification models via distillation training can include backpropagating, by the computing system, a distillation loss term to train a feature extractor of the one or more student classification models to predict feature representations similar to a feature extractor of one or more teacher classification models. The one or more teacher classification models can include a cosine classifier. In some implementations, the method can include obtaining, by the computing system, a dataset, wherein the dataset can include one or more features: processing, by the computing system, the dataset with the one or more student classification models to generate one or more class confidence scores based on the one or more features; and determining, by the computing system, one or more classification predictions based at least in part on the one or more class confidence scores. The dataset can include one or more images, and the one or more classification predictions can include one or more object classifications or image classifications. In some implementations, the dataset can include one or more samples of audio data, and the one or more classification predictions can include one or more classifications of the audio data. The one or more classification predictions can be used for determining an action to be taken by an autonomous agent or robot. In some implementations, the training dataset can include images. The training dataset can include text data. The training dataset can include audio data. In some implementations, a computer readable storage medium can include computer executable instructions that when executed by a computer will cause the computer to carry out the method. The computer readable storage medium can be included in a computer system.

Another example aspect of the present disclosure is directed to a computing system. The system can include one or more processors and one or more non-transitory computer readable media that collectively store instructions that, when executed by the one or more processors, cause the computing system to perform operations. The operations can include obtaining input data that can include one or more features for classification. The operations can include processing the image with one or more student classification models to generate one or more classifications and providing the one or more classifications as an output. In some implementations, the one or more student classification models can be trained with a training dataset with class imbalance and one or more teacher classification models. The one or more teacher classification models can be trained with the training dataset using instance-based example selection. In some implementations, the one or more student classification models can be distillation trained with the training dataset using class-balanced example selection to predict data generated by the one or more teacher classification models.

In some implementations, the input data can include one or more images, and the one or more classifications can include one or more object classifications. The input data can include one or more images, and the one or more classifications can include an image classification. In some implementations, each of the one or more teacher classification models can include a feature extraction portion configured to receive an input and generate a feature representation, and a classification portion configured to receive the feature representation and generate a classification output; and each of the one or more student classification models can include a feature extraction portion configured to receive an input and generate a feature representation, and a classification portion configured to receive the feature representation and generate a classification output. The feature extraction portion of each student classification model can be trained to predict the feature representation generated by the feature extraction portions of the one or more teacher classification models, and the classification portion of each student classification model can be trained to predict the classification output generated by the classification portion of the one or more teacher classification models.

Another example aspect of the present disclosure is directed to one or more non-transitory computer readable media that collectively store instructions that, when executed by one or more processors, cause a computing system to perform operations. The operations can include obtaining a training dataset with class imbalance. In some implementations, the operations can include training one or more teacher classification models with the training dataset using instance-based example selection. The operations can include training one or more student classification models with the training dataset using class-balanced example selection. In some implementations, training can include training the one or more student classification models to predict data generated by the one or more teacher classification models. The operations can include providing the one or more student classification models as an output.

The operations can include obtaining an image: processing the image with the one or more student classification models to generate one or more classifications; and providing for display the one or more classifications, in which the classifications can include one or more objects recognized in the image. In some implementations, training the one or more teacher classification models and training the one or more student classification models can include separately training a feature extractor and a network classifier for each of the one or more teacher classification models and each of the one or more student classification models.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs recognition model training according to example embodiments of the present disclosure.

FIG. 1B depicts a block diagram of an example computing device that performs recognition model training according to example embodiments of the present disclosure.

FIG. 1C depicts a block diagram of an example computing device that performs recognition model training according to example embodiments of the present disclosure.

FIG. 2 depicts an illustration of an example long-tailed dataset according to example embodiments of the present disclosure.

FIG. 3 depicts a block diagram of an example class-balanced distillation according to example embodiments of the present disclosure.

FIG. 4 depicts a block diagram of an example classification model according to example embodiments of the present disclosure.

FIG. 5 depicts a block diagram of an example teacher classification model training according to example embodiments of the present disclosure.

FIG. 6 depicts a flow chart diagram of an example method to perform recognition model training according to example embodiments of the present disclosure.

FIG. 7 depicts a flow chart diagram of an example method to perform image classification according to example embodiments of the present disclosure.

FIG. 8 depicts a flow chart diagram of an example method to perform recognition model training according to example embodiments of the present disclosure.

Reference numerals that are repeated across plural figures are intended to identify the same features in various implementations.

### DETAILED DESCRIPTION

### Overview

Generally, the present disclosure is directed to systems and methods for performing class-balanced distillation to train machine-learned models (e.g., recognition models such as object recognition models or other forms of classification models). Specifically, some example implementations of the present disclosure allow the feature representation to evolve over two stages. In a first stage, one or more teachers can learn (e.g., using instance-based sampling). In a second training stage, one or more students can learn from the knowledge the teachers learned in the first stage via distillation learning. The second stage can use class-balanced sampling, in order to focus on under-represented classes. This framework can naturally accommodate the usage of multiple teachers, unlocking the information from an ensemble of models to enhance recognition capabilities. Example experiments described herein show that the proposed technique consistently outperforms the state of the art on long-tailed recognition benchmarks such as ImageNet-LT and iNaturalist18. Unlike most existing work, the proposed method does not sacrifice the accuracy of head classes to improve the performance of tail classes.

Thus, example systems and methods for class-balanced distillation can include obtaining a training dataset. The training dataset can include a class imbalance such that some classes have a larger sample of training data compared to other classes. The size of the training dataset for each class may be based at least in part on the natural occurrences of the class in nature, the real-world, or the environment in which the visual recognition model will be employed in for classification tasks. In some implementations, the training dataset can include images. The training images may be paired with classification data. The training dataset can be used to train one or more teacher classification models. The training of the one or more teacher classification models can include instance-based example selection from the training dataset. In some implementations, the training dataset can be used to train one or more student classification models using class-balanced example selection. The training of the one or more student classification models can include training the student classification model to predict data generated by the one or more teacher models. The systems and methods can provide the trained one or more student classification models as an output. The one or more student classification models can then be used for visual recognition tasks such as image classification, face recognition, object detection, instance segmentation, and multi-label learning.

More particularly, training datasets can include class imbalance in which some classes have a larger number of training examples included in a training data compared to other classes. The class imbalance can be in the form of a long-tail training dataset, such that there can be classes with a large amount of training data (i.e., the head), and there can be classes with a small amount of training data (i.e., the tail). The training dataset can include image data, text data, and/or audio data. The two-stage training method can be used to mitigate the biases that would be produced by only employing instance sampling or class-balanced sampling. In particular, the instance sampling in the first stage can provide head bias, while the class-balanced sampling of the second stage can add focus to the under-represented classes.

Long-tailed recognition can be a supervised learning problem centered around trying to learn robust models that can recognize all classes while having an imbalance of data. The models being trained can include convolutional neural networks or a variety of other models. The models may be trained to intake data and output class confidence scores. The one or more teacher classification models and the one or more student classification models can include a feature extraction portion configured to receive an input and generate a feature representation, and a classification portion configured to receive the feature representation and generate a classification output. The models can contain two parameters: a feature extractor (i.e., a feature extraction portion) and a network classifier (i.e., a classification portion). The feature extractor can be used for analyzing the data to determine feature representations inside of the data. In some implementations, the feature extractor can include mapping each instance to a descriptor. The network classifier can be used to analyze the feature representation to determine a class. In some implementations, the network classifier can include a fully connected layer with output logits for denoting class confidence scores. The model can include a cosine classifier. In some implementations, the weights can be normalized before prediction. The model can include a softmax function and can be trained using a cross-entropy loss function.

Sampling during the two training stages can differ. The training can include instance sampling, or instance example selection, in the first stage and class-balanced sampling, or class-balanced example selection, in the second stage.

Instance sampling, or instance example selection, can give each instance, or training set, an equal chance to be selected for training. In this sampling method, the head classes can be sampled more than the tail classes. Therefore, classes with more training sets can be fitted more than the tail classes at this stage.

Class-balanced sampling, or class-balanced example selection, can give each class an equal chance for having training data selected. In this sampling method, the tail classes and the head classes can be sampled equally. The class-balanced sampling can address some of the underfitting of tail classes caused by the instance sampling.

The systems and methods can include decoupling the representation and classifier learning. The systems and methods can include the teacher classification models, the student classification models, or both models being trained with decoupled learning. For example, the teacher classification models feature extractor may be trained and distilled with the feature extractor of the student classification models, while the teacher classification models classifier may be trained and distilled with the classifier of the student classification models. Thus, in some implementations, distillation learning can occur at both the feature extractor and classification model levels. Alternatively, the distillation learning can occur at the feature extractor level only or at the classification model level only.

The systems and methods can include knowledge distillation by transferring information from teacher classification models to the student classification models. The student classification models can be encouraged to mimic the output of the teacher classification models. In some implementations, training the student classification model can include training the feature extraction portion of the student model to predict the feature representation generated by the feature extraction portion of the teacher model and training the classification portion of the student model to predict the classification output generated by the classification portion of the teacher model.

The systems and methods disclosed herein can improve feature representation extractors for tail classes and classifiers for head classes. A distillation loss term can be used to ensure the feature extractor of the student classification model mimics the feature extractor of the teacher classification model. Furthermore, the logits of the teacher classification model can be distilled to the student classification model to leverage the teacher information and to avoid strong bias to the tail classes. Various teacher classification models can be used to implement the class-balanced distillation benefits.

In some implementations, the classification models can be trained with different initial random seeds. Different initial random seeding for multiple teacher classification models can provide strong regularization properties and mitigate overfitting. In some implementations, each teacher classification model may be trained multiple times with the training dataset, but each of the teacher classification models can be trained with different random seeds. In some implementations, the systems and methods can include the one or more teacher classification models being an ensemble of a plurality of teacher classification models respectively generated from a plurality of different initialization parameterizations. Moreover, the teacher classification models can include differing hyper-parameters, different architectures, and/or different training datasets (e.g., different subsets of the training data on which the models are trained, for example, as a result of random selection of training examples which may result in a different subset and/or a different ordering).

In some implementations, the first stage and the second stage can include hybrid sampling that implements a weighted instance/class-balanced sampling system. In some implementations, some teacher classification models can include class-balanced sampling and other teacher classification models can include instance sampling.

The class-balanced distillation can address long-tailed recognition problems. In some implementations, the systems and methods can use five or less teacher classification models to implement the benefits of class-balanced distillation; however, the two stage teaching method can be implemented with one teacher classification model or any number of teacher classification models.

Long-tail recognition can address the real-world setting where a few of the labels are observed with very high frequency (i.e., head), while most labels appear rarely (i.e., tail), with a continuum in-between. For example, in natural world datasets, some species can be more abundant and easier to photograph than others. Similarly, for datasets of human-made and natural landmarks, some can be much more popular destinations than others.

The one or more trained student classification models can be implemented as a recognition model. The recognition model can intake a dataset and output one or more classifications. In some implementations, the recognition model can obtain a dataset. In some implementations, the dataset can include one or more features. The dataset can be processed by the recognition model to generate one or more class confidence scores. The class confidence scores can be based on the one or more features. The class confidence scores can be used to determine one or more classification predictions. The classification predictions can include one or more object classifications, one or more image classifications, and/or one or more audio classifications.

For example, the teacher classification models and the student classification model can be image classification models. The image classification models can be trained on a training dataset including image data and labels for each of the images in the training dataset. The trained student classification model can be used as an image recognition model. In some implementations, the image recognition model can intake an image and output an image classification and/or one or more object classifications.

Another example, the teacher classification models and the student classification model can be audio classification models. The audio classification models can be trained on a training dataset including audio data and labels for each of the audio files in the training dataset. The trained student classification model can be used as an audio recognition model. In some implementations, the audio recognition model can intake an audio file and output an audio classification and/or one or more waveform classifications.

The systems and methods of the present disclosure provide a number of technical effects and benefits. As one example, the system and methods can improve recognition models or other classification models. The systems and methods can further be used to improve visual recognition models by training with instance sampling and class-balanced sampling to allow for training on long-tailed training datasets without leading to common biases involved in long-tailed training datasets or other class-imbalanced datasets. Furthermore, the systems and methods can enable more accurate recognition models. Thus, the ability of a computer to perform a task (e.g., a visual recognition task) can be improved.

Another technical benefit of the systems and methods of the present disclosure is the ability to be less computationally expensive as a single model can be used in the test time for inference rather than an ensemble of models. Moreover, all the training models can be trained on the same training set, which can lower the amount of training data needed to train the models.

With reference now to the Figures, example embodiments of the present disclosure will be discussed in further detail.

### Example Devices and Systems

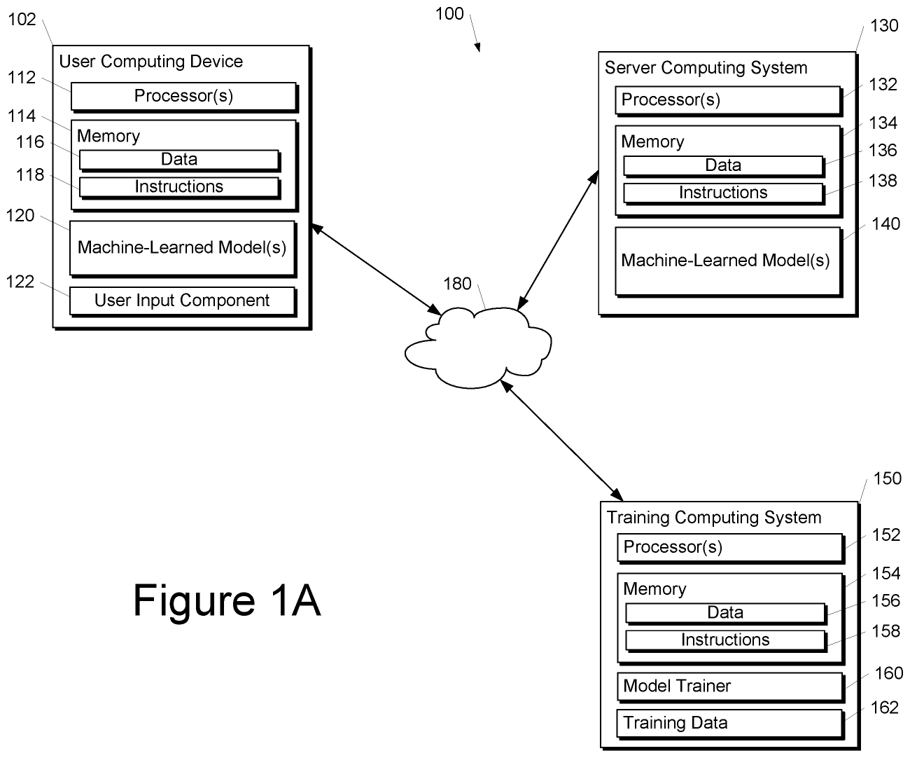

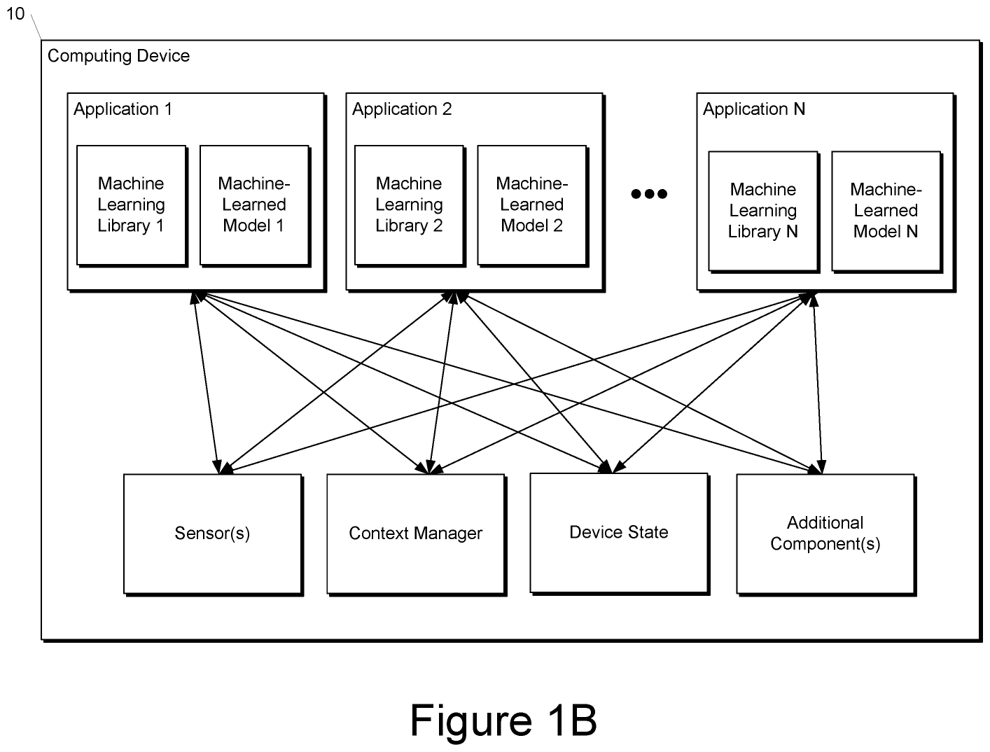

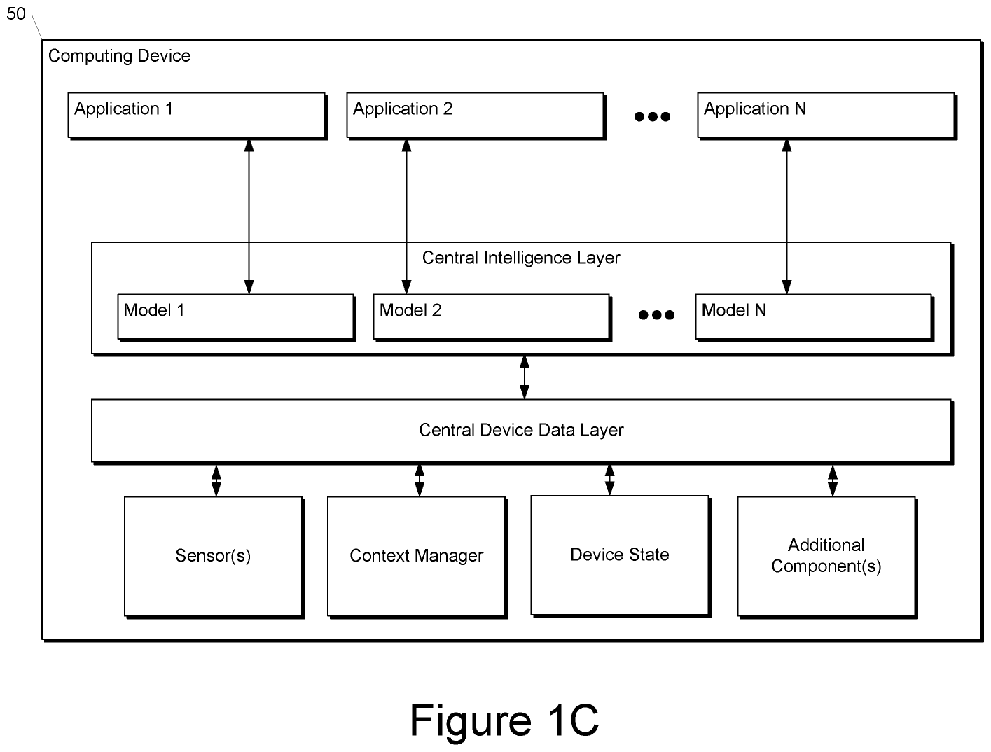

FIG. 1A depicts a block diagram of an example computing system 100 that performs classification model training according to example embodiments of the present disclosure. The system 100 includes a user computing device 102, a server computing system 130, and a training computing system 150 that are communicatively coupled over a network 80.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

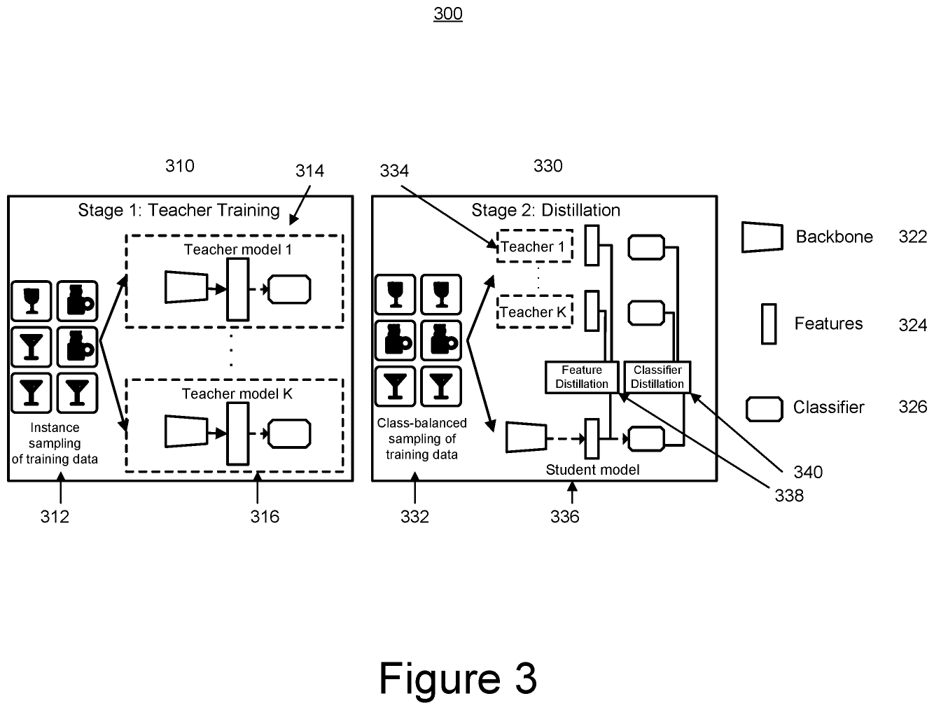

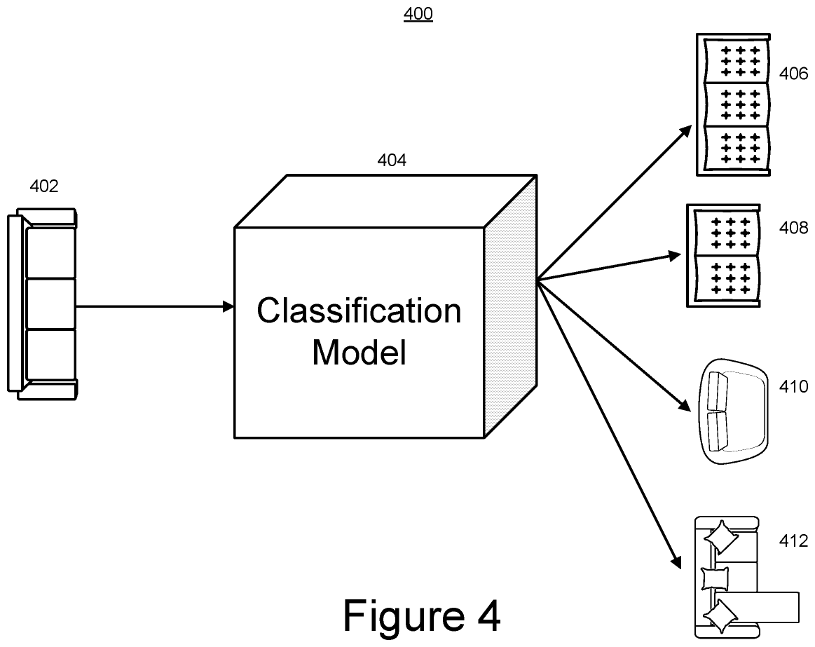

In some implementations, the user computing device 102 can store or include one or more classification models 120. For example, the classification models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example classification models 120 are discussed with reference to FIGS. 3-4 & 6-8.

In some implementations, the one or more classification models 120 can be received from the server computing system 130 over network 180, stored in the user computing device memory 114, and then used or otherwise implemented by the one or more processors 112. In some implementations, the user computing device 102 can implement multiple parallel instances of a single classification model 120 (e.g., to perform parallel recognition or classification across multiple instances of features for classification).

More particularly, the one or more classification models can include one or more teacher classification models and one or more student classification models. The student classification model can be trained for classification or recognition in a two stage process. The first stage can include training one or more teacher classification models using a training dataset sampled with instance example selection. The second stage can include training the one or more student models with the training dataset sampled with class-balanced example selection and distillation of the teacher classification model knowledge, such that the student classification models mimic the predictions of the one or more teacher classification models. The trained student classification model can then be used for classification or recognition tasks, such that the student classification model can intake input data and output classification predictions related to the processed input data.

Additionally or alternatively, one or more classification models 140 can be included in or otherwise stored and implemented by the server computing system 130 that communicates with the user computing device 102 according to a client-server relationship. For example, the classification models 140 can be implemented by the server computing system 140 as a portion of a web service (e.g., a classification or recognition service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned classification models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 3-4 & 6-8.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the classification models 120 and/or 140 based on a set of training data 162. The training data 162 can include, for example, a training dataset with class imbalance. The class imbalance can include some classes with a larger amount of training data compared to some classes with a smaller amount of training data. The training dataset can include image data, video data, audio data, text data, or a variety of other data related to the classification or recognition task the model is being trained to complete. In some implementations, the training dataset can include images and labels for the images to train the model to complete image classification tasks.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160) includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output. In some implementations, the input to the machine-learned model(s) can be Internet resources (e.g., web pages), documents, or portions of documents or features extracted from Internet resources, documents, or portions of documents. The output generated by the machine-learned model(s) for a given Internet resource, document, or portion of a document may be a score for each of a set of topics, with each score representing an estimated likelihood that the Internet resource, document, or document portion is about the topic. In some implementations, the input to the machine-learned model(s) can be features of a personalized recommendation for a user, e.g., features characterizing the context for the recommendation, e.g., features characterizing previous actions taken by the user. The output generated by the machine-learned model(s) may be a score for each of a set of content items, with each score representing an estimated likelihood that the user will respond favorably to being recommended the content item.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. For example, the output generated by the machine-learned model(s) may be a score for each of a set of pieces of text, each score representing an estimated likelihood that the piece of text is the correct transcript for the utterance. In some cases, the task comprises encrypting or decrypting input data. In some cases, the task comprises a microprocessor performance task, such as branch prediction or memory address translation.

The output(s) from the machine-learned model may be used to determine actions to be performed by an autonomous agent or system. For example, a robotic agent or autonomous vehicle may use the output of a computer vision task as described herein to determine a suitable trajectory to follow; or an alteration to make to its current trajectory, and adapt its motion accordingly. In another example, a computing device may use the output of a speech recognition task as described herein to identify a command issued to the computing device by a user, with the computing device performing the necessary action to fulfil the command. For example, the computing device may identify a user command to retrieve media content from a web server for play back to the user, or to alter environmental conditions by adjusting one or more lighting or heating controls for the environment.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

Real-world imagery can often be characterized by a significant imbalance of the number of images per class, leading to long-tailed distributions. Training with long-tailed distributions can be improved by a two stage training method that can include training the feature extractor and classifier separately. An example training method, Class-Balanced Distillation (CBD), can leverage knowledge distillation to enhance feature representations. CBD can allow the feature representation to evolve in the second training stage, guided by teachers learned in the first stage. The second stage can use class-balanced sampling, in order to focus on under-represented classes. The framework can naturally accommodate the usage of multiple teachers, unlocking the information from an ensemble of models to enhance recognition capabilities. CBD can consistently outperform the state of the art on long-tailed recognition benchmarks such as ImageNet-LT and iNaturalist18. The method does not sacrifice the accuracy of head classes to improve the performance of tail classes.

Long-tailed recognition can be a supervised learning problem where labeled training data can be provided, but with one key distinction: a strong imbalance in terms of instances (images) per class in the training set, following a long-tailed distribution. The goal can be to learn robust models that can recognize all classes, regardless of the number of instances in the training set.

The dataset can have a given set of n instances (images) X:={x₁, . . . , xₙ}. Each image can be labeled according to Y:={y₁, . . . yₙ} with yᵢϵC, where C:={1, . . . c} can be a label set for c classes. Let Cⱼ denote the subset of instances labeled as class j, and nⱼ=|Cⱼ| as its cardinality. The training dataset can follow a long-tailed distribution (i.e., a majority of {n₁, . . . , n_{c}} can be greatly smaller than max({n₁, . . . , n_{c}})). Despite the training set imbalance, at test time, the goal can be to accurately recognize all classes (i.e., a balanced test set is used (the number of test images for each class is the same)).

The learned model (e.g., a trained convolutional neural network) can take an input image and can output class confidence scores. The model can be denoted as ϕ_{θ,W}:X→R^{C}. The model can contain two components, corresponding to the learnable parameters θ and W:1) a feature extractor, mapping each instance xᵢ to a descriptor vᵢϵR^{d}, by vᵢ:=f_{θ}(xᵢ); 2) a network classifier, typically consisting of a fully connected layer which outputs logits zᵢϵR^{C}, by zᵢ:=g_{W}(vᵢ), denoting class confidence scores.

In some implementations, g_{W} can be modeled as a cosine classifier, where feature descriptors and classifier weights are [symbol] ₂-normalized before the prediction. The output can become zᵢ:=γW̅^{T}ν̅ᵢ, where ν̅ᵢ corresponds to the [symbol] ₂-normalized version of vᵢ, W̅ the column-wise [symbol] ₂-normalized version of W, and γ is a scaling parameter which is fixed.

Parameters θ and W can be learned during the training stage. Learning can include minimizing the loss of the model's output over the training set X:

$$L ( X , Y ; θ , W ) := {\sum }_{i = 1}^{n} ℓ ( σ ( {z}_{i} ) , {y}_{i} ) ,$$

where zᵢ=ϕ_{θ,W} (xᵢ) is the output of the model, σ(⋅) is the softmax activation function, and [symbol] (⋅) is the cross-entropy loss function.

In the context of long-tailed problems, different sampling strategies can be used to adjust the data distribution at training time. For example, instance sampling and/or class-balanced sampling can be utilized.

Instance sampling can be a simple method where each instance xᵢϵX has the same probability of being chosen in the mini-batch. Instances from head classes can be sampled more frequently than those from tail classes due to the long-tailed nature of the dataset, which may lead to underfitting of tail classes. In some implementations, the probability of sampling an instance from class j can be denoted as pⱼ. Under instance sampling, the probability can be pⱼ=nⱼ/n.

Class-balanced sampling can address data imbalance by equalizing pⱼ across classes. Under this strategy, each class can have the same probability of being selected (i.e., pⱼ=1/c for all j=1, . . . , c). Even though the strategy can balance the data distribution, it can also reduce the diversity of examples from head classes. In this sampling method, tail classes can be sampled much more frequently compared to head classes. As a result, the model can tend to overfit the tail classes, and a sub-optimal performance may be observed.

The training method can include training the two components of the model ϕ_{θ,W} with different sampling strategies. The feature extractor f_{θ} can be trained with instance sampling. Then, f_{θ} can be frozen, and the network classifier g_{W} can be trained with class-balanced sampling.

Knowledge distillation can refer to transferring information from a teacher model \hat{ϕ}_{\hat{θ},Ŵ} to a student model ϕ_{θ,W}. Distillation can be achieved by encouraging the student model to mimic the output of the teacher model. The loss objective can become:

$$L ( X , Y ; θ , W ) := {\sum }_{i = 1}^{n} ( 1 - α ) \cdot ℓ ( σ ( {z}_{i} ) , {y}_{i} ) + α \cdot {T}^{2} \cdot ℓ ( σ ( \frac{{z}_{i}}{T} ) , σ ( / T ) ) ,$$

where \hat{z}ₗ=\hat{ϕ}_{\hat{θ},Ŵ}(xᵢ) is the teacher model's output. Tis the temperature parameter used for distillation, and a balances the two loss terms. Setting T>1 can increase the weight of the smaller logits and can encourage the student model to match its output to their values.

To develop an enhanced two-stage learning method for long-tailed recognition may focus on improving (A) the feature representations for tail classes, and (B) the classifier for head classes.

The first stage learning can include instance sampling to obtain a teacher model \hat{ϕ}_{\hat{θ},Ŵ}. The second stage can use class-balanced sampling. First, to address (A), the training process can introduce a distillation loss term to encourage the feature extractor of the student f_{θ} to become similar to the teacher's: this reuses the first-stage feature knowledge, but still leaves room for improvement with the class-balanced training. Second, to tackle (B), the training process can distill the teacher logits into the student model, to encourage the classifier g_{W} to leverage the teacher information and can avoid a strong bias to the tail classes. The complete loss function can be written as:

$$L ( X , Y ; θ , W ) := {\sum }_{i = 1}^{n} ( 1 - α ) \cdot ℓ ( σ ( {z}_{i} ) , {y}_{i} ) + α \cdot ( {T}^{2} \cdot ℓ ( σ ( \frac{{z}_{i}}{T} ) , σ ( \begin{matrix} \\ T\end{matrix} ) ) + {βℓ}_{F} ( {v}_{i} , {\hat{v}}_{i} ) ) ,$$

where \hat{ν}ᵢ=\hat{f}_{\hat{θ}}(xᵢ) is the feature descriptor produced by the teacher model, and [symbol] _{F}(ν, x)=1−cos (ν, x) tries to minimize the cosine distance between two feature descriptors.

The entire class-balanced distillation setup can be agnostic to the type of teacher model \hat{ϕ}_{\hat{θ},Ŵ}. The agnostic nature can enable the training to leverage other existing models to, if desired, put more emphasis on tail classes.

Distillation can be further extended to transfer information from multiple teacher models. The resulting student model can tend to have stronger regularization properties and reduced over-fitting. The same teacher model can be trained multiple times with the same sampling strategy but different initial random seeds, composing a teacher model ensemble. Different initial random seeds change weight initialization for the parameters, as well as the order of classes that are sampled during the training.

Let \hat{ϕ}_{\hat{θ}}_{^{k}}_{,Ŵ}_{^{k}}^{k} denote the k-th teacher model in the ensemble. When training the student model ϕ_{θ,W} in the second stage, the training process can combine the information from multiple models as:

$$L ( X , Y ; θ , W ) := {\sum }_{i = 1}^{n} ( 1 - α ) \cdot ℓ ( σ ( {z}_{i} ) , {y}_{i} ) + α \cdot ( {T}^{2} \cdot ℓ ( σ ( \frac{{z}_{i}}{T} ) , σ ( \frac{T}{} ) ) + β {ℓ}_{F} ( {v}_{i} , {\hat{v}}_{i} ) ) ,$$

where

$${\hat{z}}_{i}^{avg} = \frac{1}{K} {\sum }_{k}^{K} {\hat{z}}_{i}^{k}$$

corresponds to the average logits of K teacher models, \hat{V}ᵢ=[\hat{ν}ᵢ¹, . . . , \hat{ν}ᵢ^{K}] is the concatenation of K feature descriptors output by the teacher models, and h:R^{d}→R^{d·K} is a linear layer which maps the feature descriptor νᵢ to a higher dimensional space, where the cosine distance can be computed (e.g., in this implementation, the classifier g_{W} is learned on top of h(νᵢ)). By transferring information from multiple teacher models, the student model can become a robust final model ϕ_{θ,W} which is used for the evaluation of test images.

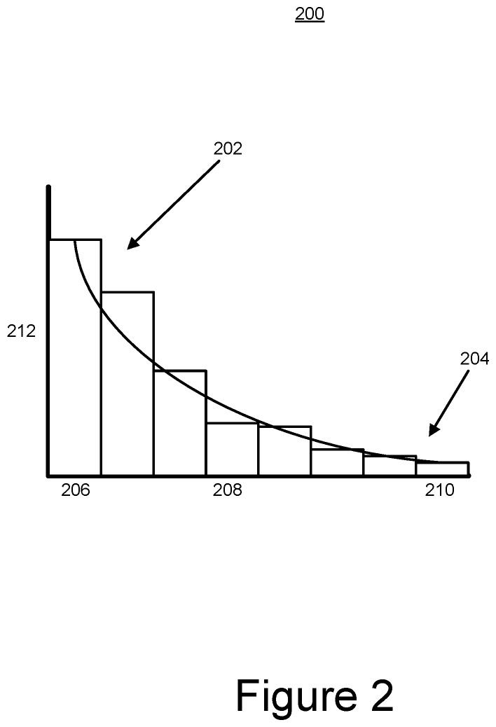

FIG. 2 depicts an illustration of an example long-tailed training dataset 200 according to example embodiments of the present disclosure. In some implementations, the long-tailed training dataset 200 includes one or more head classes 202 descriptive of classes with a large amount of training data compared to the tail classes 204. Thus, in some implementations, the long-tailed training dataset 200 can include classes 206, 208, & 210 that include training data operable to train classification models.

FIG. 2 depicts an illustration of a long-tailed training dataset 200 via a bar graph with various classes on the x-axis and the training set per class size on the y-axis. For example, the taller the bar, the larger amount of training data for the particular class. In this illustration, the first class 206 has the largest amount of training data of the dataset and can be referred to as a head class 202. The last class 210 can have the least amount of training data and can be referred to as a tail class 204. The training dataset 200 can include a plurality of other classes with varying training data size such as the fourth class 208 with a larger amount of data to the last class 210 and substantially less data than the first class 206. Long-tailed training datasets, like the one depicted, can lead to problems of overfitting either the head classes 202 or the tail classes 204. The class-balanced distillation systems and methods disclosed herein can mitigate biases caused by certain sampling methods of long-tailed datasets.

FIG. 3 depicts a block diagram of an example training process 300 according to example embodiments of the present disclosure. In some implementations, the example training process 300 is trained to receive a set of input data 312 and 332 descriptive of a training dataset and, as a result of receipt of the input data 312 and 332, provide a trained student classification model 336 that can be used for classification or recognition tasks. Thus, in some implementations, the training process 300 can include a first stage 310 and a second stage 330) that are operable to mitigate biases.

The training process 300 of FIG. 3 includes a first stage 310 and a second stage 330 for training a student classification model 336. The first stage 310 can include training one or more teacher classification models 314 & 316. The first stage 310 can include sampling the training dataset with instance sampling 312 in which head classes may have more training data processed compared to the tail classes. For example, training the classification models to label different drinking classes, such as wine glasses, coffee mugs, and cocktail glasses. The first teacher classification model 314 can be trained on the same training data as teacher classification model K 316. In some implementations, the first teacher classification model 314 and the teacher classification model K 316 can receive different initial random seeds.

The second stage 330 can include knowledge distillation from the teacher classification models 334 to the one or more student classification models 336. The second stage 330) can include class-balanced sampling 332 that can focus training on the under-represented tail classes. Moreover, the feature extractor and the classifier may be trained separately such that the first stage 310 and the second stage 330 can include parallel and separate training. For example, the second stage 330 can have feature distillation 338 and a separate classifier distillation 340 to distill knowledge to the student classification model 336.

In this implementation, the one or more teacher classification models and the one or more student classification models can include a backbone 322, a feature extractor 324, and a classifier 326.

FIG. 4 depicts a block diagram of an example classification model 400 according to example embodiments of the present disclosure. In some implementations, the classification model 400 is trained to receive a set of input data 402 descriptive of an object and, as a result of receipt of the input data 402, provide output data 406, 408, 410, & 412 that predicts a classification of the object in the input data 402. Thus, in some implementations, the classification model 400 can include an image classification model 402 that is operable to determine the object in the image.

The classification model 400 of FIG. 4 can be trained to be a specialized image classification model 404. In the depicted example, the trained classification model 404 can obtain a dataset 402 including one or more features descriptive of an object. The trained classification model 404 can process the dataset 402 to determine and generate one or more classification predictions. The classification predictions can be determined and/or include class confidence scores descriptive of a determined likelihood that the input data depicts that class of object. For example, a couch in the input dataset 402 may be processed by the classification model 404 to output a class confidence score for each of the trained classes, which can include a classic couch class 406, a classic loveseat class 408, a wedge loveseat class 410, and a sectional sofa class 412. In this example, the classification model can produce one or more classification predictions descriptive of a classic couch class 406 classification. The trained classification model 404 may output a class confidence score for each of the classes in which the classic couch class has the best score.

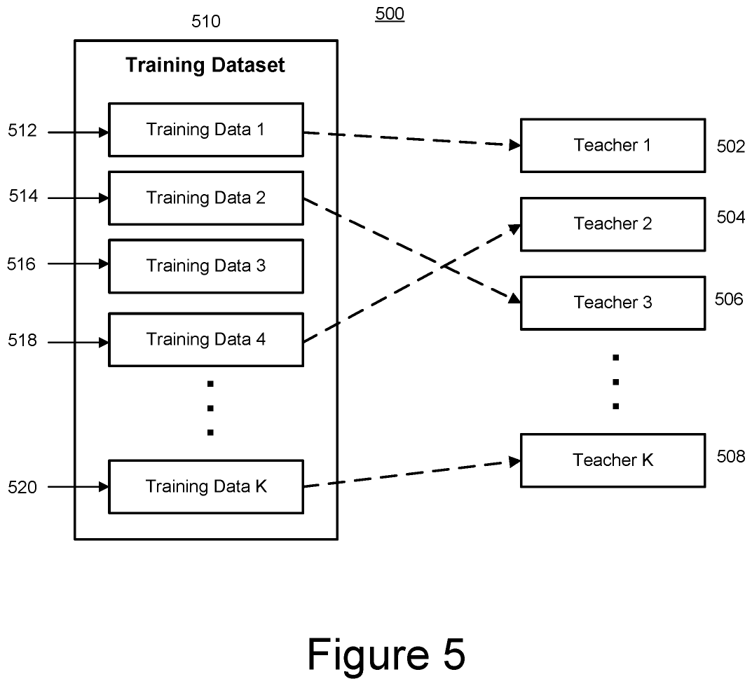

FIG. 5 depicts a block diagram of an example training process 500 according to example embodiments of the present disclosure. In some implementations, the training process 500 includes a training dataset 510 descriptive of various classes and a set of teacher classification models 502, 504, 506, & 508. Thus, in some implementations, the training process 500 can include a random initial seeding.

Random initial seeding, as depicted by the training process 500 in FIG. 5, can mitigate biases caused by initial training data bias. In the depicted example, the training dataset can include a plurality of training sets for training classification models. The training of the student classification models may be at least partially based on knowledge distillation from one or more teacher models. The one or more teacher classification models can be trained with different random initial seeds, such that the first teacher classification model 502 can be first trained on a first training data 512, the second teacher classification model 504 can be first trained on a fourth training data 518, the third teacher classification model 506 can be first trained on a second training data 514, the Kth teacher classification model 508 can be first trained on a Kth training data 520, and so forth. Moreover, the initial random seeding may continue for an nth number of teacher classification models such that a third training data 516 may be an initial training data set for a teacher classification model not depicted.

### Example Methods

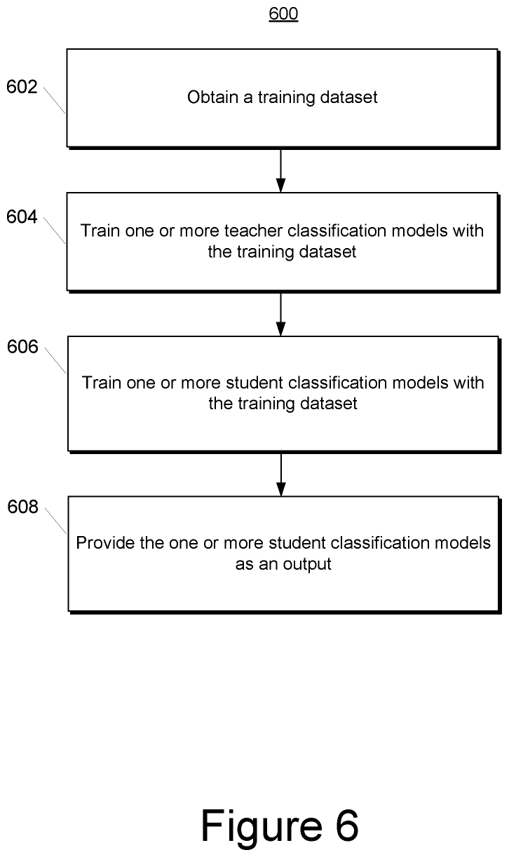

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a training dataset. The training dataset can include a class imbalance. In some implementations, the training dataset can be a long-tailed training dataset. The training dataset can include image data, video data, audio data, and/or text data. The training dataset may include class labels to aid in training.

At 604, the computing system can train one or more teacher classification models with the training dataset. The teacher classification models can be trained on the training dataset with instance example selection. The teacher classification models can include a feature extractor and a classifier. The feature extractor and the classifier may be trained separately.

At 606, the computing system can train one or more student classification models with the training dataset. The student classification model can be trained on the training dataset with class-balanced example selection. In some implementations, the knowledge of the one or more teacher classification models can be distilled to the student classification model, such that the student classification model may mimic the classification predictions of the one or more teacher classification models.

At 608, the computing system can provide the one or more student classification models as an output. The student classification models can then be used for one or more classification or recognition tasks. For example, the classification model training may train the student classification model to be able to classify objects in an image. The student classification model may be able to obtain an image and output classifications for each object in the image.

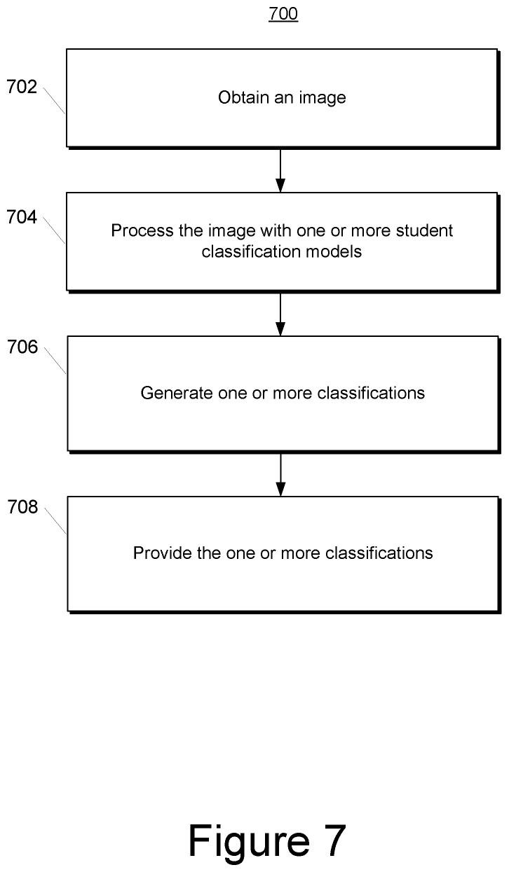

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain an image. The image can include one or more features descriptive of objects in the image.

At 704, the computing system can process the image with one or more student classification models. Processing of the image with the student classification model can include extracting feature representations from the image with the model's feature extractor and classifying the feature representations with the model's classifier. In some implementations, the student classification model may determine one or more class confidence scores for each of the one or more features in the image.

At 706, the computing system can generate one or more classifications. The one or more classifications can be generated as an output from processing the image. In some implementations, the classifications are based on the one or more class confidence scores. The one or more predictions can be object class predictions, recognition predictions, or image classification predictions. For example, one of the classifications may be an object classification identifying a bird depicted inside of the image.

At 708, the computing system can provide the one or more classifications. The one or more classifications can be provided through a user interface and may include one or more class confidence scores. The one or more classifications may be provided with the one or more extracted feature representations.

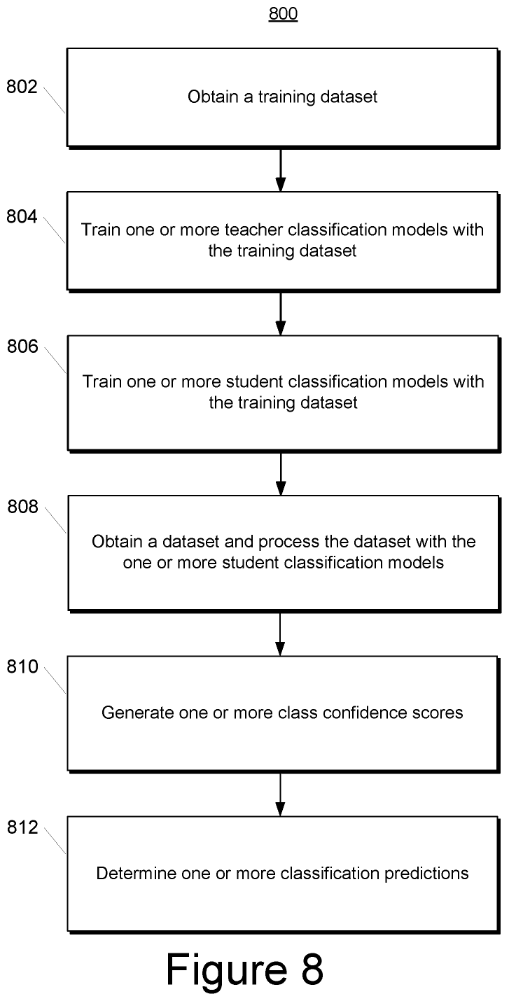

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a training dataset. The training dataset can include a class imbalance including head classes with a large amount of training data and tail classes with a small amount of training data.

At 804, the computing system can train one or more teacher classification models with the training dataset. The one or more teacher classification models can be trained on the training dataset with instance sampling. The teacher classification models can be trained with different initial random seeding in which one or more of the teacher classification models may be trained with the training dataset starting with different data in the training dataset.

At 806, the computing system can train one or more student classification models with the training dataset. The one or more student classification models can be trained on the training dataset with class-balanced sampling. Moreover, the one or more student classification models can be trained to mimic classification predictions of the teacher classification models using knowledge distillation. In some implementations, the feature extractors of the classification models and the classifiers of the classification models may be trained separately.

At 808, the computing system can obtain a dataset and process the dataset with one or more student classification models. The one or more trained student classification models can process the dataset to extract feature representations to be processed by the classifiers of the one or more models. The dataset can include an image, an audio file, or text.

At 810, the computing system can generate one or more class confidence scores. The class confidence scores can be determined by the one or more student classification models and can be descriptive of a likelihood the processed data matches a particular class.

At 812, the computing system can determine one or more classification predictions. The one or more classification predictions can include object classifications, image classification, audio classification, text classifications, etc. The one or more classification predictions can include classification predictions based on the one or more class confidence scores. For example, the student classification model may output a classification prediction based on whether a class confidence score meets a threshold. The threshold may be a certainty level that the class is present in the processed dataset. Alternatively, one or more classification predictions can be determined based on one or more class confidence scores being better than the other class confidence scores.

### Experimentation Data

To test the training, the process can be tested with two long-tailed datasets, namely ImageNet-LT and iNaturalist18. ImageNet-LT can be an artificially created subset of the original ImageNet dataset, where the classes can follow a long-tailed distribution in the training set. ImageNet-LT can have 1000 classes and the number of training images per class can vary from 1280 to 5. The iNaturalist18 training set can be long-tailed by nature and can contain 8,142 classes with the range of 1000 to 2 images per class. The validation and test sets for both datasets can be balanced.

Top-1 accuracy can be the evaluation metric for all experiments. Experimentation can report the accuracies for many-shot classes (more than 100 images per class), mid-shot classes (between 100 and 20 images), and few-shot classes (less than 20 images) separately.

Experimentation can include using ResNet-10 and ResNeXt-50 architectures for ImageNet-LT, and ResNet-{50,101} for iNaturalist18. The distillation temperature can be set as T=5. Other parameters, such as α, β and the number of teacher models K can be chosen based on the accuracy in the validation set.

Class-balanced Distillation can include two stages. In the first stage, the teacher models can be trained with instance sampling. If K>1 teacher models are trained in the first stage, this variant can be denoted as CBD_{K}. A cosine classifier can be used when training the model. In the second stage, the final model can be trained from scratch with class-balanced sampling and distillation. The networks can be trained for 90 epochs on ImageNet-LT and 200 epochs on iNaturalist18 in both stages.

The hyper-parameters for CBD can provide some impact. Experiments in regards to hyper-parameters can be evaluated on the validation set of ImageNet-LT.

The distillation coefficient α parameter can control the strength of distillation in the loss function. The optimal value of α can depend on the strength of the teacher model. ResNeXt-50 can favor a higher a for the best accuracy than ResNet-10 does. The distillation coefficient can be set as α=0.8 for the single-teacher variant CBD as a fixed variable for the remaining experiments.

Feature learning can make a first-class citizen for long-tailed recognition and employ distillation at the feature representation level. β can be varied when training CBD to study its effect. Setting β=0, 1, 10 can achieve 44.0, 44.7 and 43.8 validation accuracy respectively on ImageNet-LT with ResNet-10. As a control, β can be set as β=1 for the remaining experiments.

K teacher models can be trained when ensembling is used. The teacher models can be then fused into a single model with distillation. α=0.8 can achieve the best validation accuracy with ResNet-10 and ResNeXt-50. The performance may not increase substantially when more than 5 teachers are used. The control for comparing baselines can include setting α=0.8 and K=5 for CBD_{K}.

ImageNet-LT test set and iNaturalist18 validation set can be used for evaluation of baselines.

Class Bal.-Cos can refer to a network trained with the cosine classifier and class-balanced sampling. Instance-Cos can refer to the teacher model of CBD (i.e., a network trained with the cosine classifier and instance sampling). Fine-tuning can refer to fine-tuning the network in the second stage instead of distillation (i.e., the network can be trained with instance sampling in the first stage and fine-tune the existing model with class-balanced sampling in the second stage). cRT-Cos can be our re-implementation of cRT with the cosine classifier. It may use Instance-Cos in the first stage and can learn a cosine classifier with class-balanced sampling in the second stage. cRT-Cos+Distill can be an extension of cRT-Cos where an additional logit distillation loss can be added when learning the classifier in the second stage.

Another variant of the method can be referred to as CBD.NCM and can use the same feature extractor as CBD, but the inference can be done with the Nearest Class Mean classifier (NCM) at test time. NCM can be a non-parametric classifier and can use class mean vectors for classification. Experimentation can include first extracting feature vectors of all images in each class and taking their mean to compute the class mean vectors. At test time, the inference can be done by computing the cosine similarity between the test vector and class mean vectors. The variant can be meant to show the performance of the trained feature vectors of CBD without any learned classifier. Similar to CBD.NCM, experimentation can introduce the NCM-Cos baseline, where the NCM classifier can be applied to the Instance-Cos teacher model.

Table 1 can report the comparisons against the baselines. Experimentation results can show the accuracy of many-shot, mid-shot, and few-shot classes separately, in addition to the overall accuracy for all classes. CBD variants can show improvements over the baselines. In some implementations, CBD may perform significantly higher than fine-tuning, which performs even worse than the cRT-Cos baseline on ImageNet-LT. cRT-Cos+Distill, which uses distillation only for the classifier learning in the second stage can perform worse than cRT-Cos on ImageNet-LT. It may improve performance for the head classes but suffers from worse accuracy in the tail classes. The results can show the benefit of optimizing the entire network with CBD.

| | ImageNet-LT | | | | iNaturalist18 | | | |
|---|---|---|---|---|---|---|---|---|
| | Many- | Mid- | Few- | | Many- | Mid- | Few- | |
| Method | shot | shot | shot | All | shot | shot | shot | All |

BASELINES

| | | | | | | | | |
|---|---|---|---|---|---|---|---|---|
| Class Bal. Cos | 63.5 | 38.2 | 13.4 | 44.6 | 66.7 | 64.6 | 60.5 | 63.2 |
| Instance-Cos | 67.1 | 41.6 | 14.6 | 47.7 | 74.5 | 65.7 | 58 | 63.6 |
| Fine-tuning | 64.3 | 47.3 | 23.9 | 50.7 | 72.7 | 67.1 | 63.4 | 66.2 |
| NCM-Cos | 62.1 | 46.2 | 27.2 | 49.7 | 69.4 | 63.2 | 59.1 | 62.2 |
| cRT-Cos | 65 | 46.8 | 25.1 | 50.9 | 72 | 66.6 | 62.6 | 65.5 |
| cRT-Cos + Distill | 65.7 | 44.7 | 21.4 | 49.6 | 72.9 | 67.1 | 62.2 | 65.7 |

CBD

| | | | | | | | | |
|---|---|---|---|---|---|---|---|---|
| CBD | 69.3 | 46.8 | 20.2 | 51.9 | 73 | 69.8 | 66.5 | 68.8 |
| CBD_{.NCM} | 66.6 | 48.5 | 28.5 | 52.7 | 69.6 | 66.4 | 64 | 65.8 |
| CBD_{K.NCM} | 70.7 | 48 | 20.9 | 53 | 75.5 | 73.7 | 69.4 | 72.2 |
| CBD_{K} | 67.3 | 50.4 | 31.1 | 54.3 | 72.4 | 71.5 | 68.9 | 70.6 |

Table 1 displays the results of a baseline comparison, including a comprehensive evaluation on ImageNet-LT (ResNeXt-50) and iNaturalist18 (ResNet-50). The accuracy for many-shot (>100 images), mid-shot (20-100 images) and few-shot (<20 images) classes are reported separately.

Note that CBD.NCM can significantly outperform NCM-Cos. The CBD training method can further improve the feature vectors over the first-stage. Better accuracy for both head and tail classes with CBD.NCM compared to NCM-Cos can occur.

Furthermore, the results can show that the two-stage baselines reduce the accuracy of many-shot classes in the second stage. This can also be true for CBD.NCM and CBD_{K}.NCM, which favor few-shot classes after the second stage. Nevertheless, CBD and CBD_{K} may provide a more balanced improvement over the first-stage models by using the network classifier during inference. In fact, CBD_{K} can show improvements for all class types for both datasets. This may show that our method also provides a better network classifier in addition to the enhanced feature representations.

Tables 2 and 3 compare the CBD variants against the state of the art on ImageNet-LT and iNaturalist18 datasets, respectively. The CBD method can show consistent improvement for both datasets with different network architectures. On ImageNet-LT, more than 3% improvement with CBD_{K} (ResNet-10) and more than 4% with CBD_{K}.NCM (ResNeXt-50) over the prior best can occur. CBD_{K} may outperform the state of the art on iNaturalist18 by 2.6% with ResNet-50. Relative improvement may remain similar when a larger network is used, and 2.5% improvement over state of the art with CBD_{K} with ResNet-101 may occur.

| | | |
|---|---|---|
| Method | ResNet-10 | ResNeXt-50 |

PREVIOUS WORK

| | | |
|---|---|---|
| RCB | 29.9 | — |
| Focal Loss | 30.5 | — |
| FSA | 35.3 | — |
| NCM | 35.5 | 47.3 |
| OLTR | 37.3 | 46.3 |
| LFME + OLTR | 38.8 | — |
| LWS | 41.4 | 49.9 |
| cRT | 41.8 | 49.5 |

CBD

| | | |
|---|---|---|
| CBD | 43.5 | 51.9 |
| CBD_{.NCM} | 39.6 | 52.7 |
| CBD_{K} | 45.1 | 53 |
| CBD_{K.NCM} | 41.6 | 54.3 |

Table 2 displays results of an ImageNet-LT state-of-the-art comparison, including a comparison of CBD variants against the state of the art, with network backbones ResNet-10 and ResNext-50.

| | | |
|---|---|---|
| Method | ResNet-50 | ResNet-101 |

PREVIOUS WORK

| | | |
|---|---|---|
| CB-Focal | 61.1 | — |
| NCM | 63.1 | 65.3 |
| LDAM | 64.6 | — |
| FSA | 65.9 | 68.4 |
| cRT | 67.6 | 70.7 |
| RCB | 67.6 | — |
| LDAM + DRW | 68 | — |
| LWS | 69.5 | 69.7 |
| BBN | 69.6 | — |

CBD

| | | |
|---|---|---|
| CBD | 68.8 | 69.8 |
| CBD_{.NCM} | 65.8 | 67.1 |
| CBD_{K} | 72.2 | 73.2 |
| CBD_{K.NCM} | 70.6 | 72.2 |

Table 3 displays results of an iNaturalist18 state-of-the-art comparison, including a comparison of CBD variants against the state of the art, with network backbones ResNet-50 and ResNet-101.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for improved machine learning on imbalanced datasets, the method comprising:
obtaining, by a computing system comprising one or more computing devices, a training dataset with class imbalance;
training, by the computing system, one or more teacher classification models with the training dataset using instance-based example selection;
training, by the computing system, one or more student classification models with the training dataset using class-balanced example selection, wherein training the one or more student models comprises training the one or more student classification models to predict data generated by the one or more teacher classification models via distillation training; and
providing, by the computing system, the one or more student classification models as an output.

2. The method of claim 1, wherein:
each of the one or more teacher classification models comprises a feature extraction portion configured to receive an input and generate a feature representation and a classification portion configured to receive the feature representation and generate a classification output;
each of the one or more student classification models comprises a feature extraction portion configured to receive an input and generate a feature representation and a classification portion configured to receive the feature representation and generate a classification output; and
training, by the computing system, the one or more student classification models to predict data generated by the one or more teacher classification models via distillation training comprises:
training, by the computing system, the feature extraction portion of each student classification model to predict the feature representation generated by the feature extraction portions of the one or more teacher classification models; and
training, by the computing system, the classification portion of each student classification model to predict the classification output generated by the classification portion of the one or more teacher classification models.

3. The method of claim 1, wherein the one or more teacher classification models comprise an ensemble of a plurality of teacher classification models respectively generated from a plurality of different initialization parameterizations.

4. The method of claim 3, wherein training, by the computing system, the plurality of teacher classification models with the training dataset using instance-based example selection comprises using, by the computing system, different initial random seeds of the training dataset for the plurality of teacher classification models.

5. The method of claim 1, wherein the one or more teacher classification models comprise an ensemble of a plurality of teacher classification models that have a plurality of different sets of hyperparameters.

6. The method of claim 1, wherein the one or more teacher classification models comprise an ensemble of a plurality of teacher classification models that have a same initial parameterization but are trained on different randomly-selected subsets of the training data.

7. The method of claim 1, wherein the one or more student classification models comprise a convolutional neural network.

8. The method of claim 1, wherein training, by the computing system, the one or more student classification models to predict data generated by the one or more teacher classification models via distillation training comprises backpropagating, by the computing system, a distillation loss term to train a feature extractor of the one or more student classification models to predict feature representations similar to a feature extractor of one or more teacher classification models.

9. The method of claim 1, wherein the one or more teacher classification models comprise a cosine classifier.

10. The method of claim 1, further comprising:
obtaining, by the computing system, a dataset, wherein the dataset comprises one or more features;
processing, by the computing system, the dataset with the one or more student classification models to generate one or more class confidence scores based on the one or more features; and
determining, by the computing system, one or more classification predictions based at least in part on the one or more class confidence scores.

11. The method of claim 10, wherein the dataset comprises one or more images and the one or more classification predictions comprise one or more object classifications or image classifications.

12. The method of claim 10, wherein the dataset comprises one or more samples of audio data and the one or more classification predictions comprise one or more classifications of the audio data.

13. The method of claim 10, wherein the one or more classification predictions are used for determining an action to be taken by an autonomous agent or robot.

14. The method of claim 1, wherein the training dataset comprises images.

15. The method of claim 1, wherein the training dataset comprises text data.

16. The method of claim 1, wherein the training dataset comprises audio data.

17. (canceled)

18. (canceled)

19. A computing system, the computing system comprising:
one or more processors;
one or more non-transitory computer readable media that collectively store instructions that, when executed by the one or more processors, cause the computing system to perform operations, the operations comprising:
obtaining input data that comprises one or more features for classification;
processing the input data with one or more student classification models to generate one or more classifications; and
providing the one or more classifications as an output;
wherein the one or more student classification models have been trained with a training dataset with class imbalance and one or more teacher classification models, wherein the one or more teacher classification models have been trained with the training dataset using instance-based example selection, wherein the one or more student classification models have been distillation trained with the training dataset using class-balanced example selection to predict output data generated by the one or more teacher classification models.

20. The computing system of claim 19, wherein the input data comprises one or more images and the one or more classifications comprise one or more object classifications.

21. The computing system of claim 19, wherein the input data comprises one or more images and the one or more classifications comprise an image classification.

22. The computing system of claim 19, wherein:
each of the one or more teacher classification models comprises a feature extraction portion configured to receive an input and generate a feature representation and a classification portion configured to receive the feature representation and generate a classification output;
each of the one or more student classification models comprises a feature extraction portion configured to receive an input and generate a feature representation and a classification portion configured to receive the feature representation and generate a classification output;
the feature extraction portion of each student classification model has been trained to predict the feature representation generated by the feature extraction portions of the one or more teacher classification models; and
the classification portion of each student classification model has been trained to predict the classification output generated by the classification portion of the one or more teacher classification models.

23. One or more non-transitory computer readable media that collectively store instructions that, when executed by one or more processors, cause a computing system to perform operations, the operations comprising:
obtaining a training dataset with class imbalance;
training one or more teacher classification models with the training dataset using instance-based example selection;
training one or more student classification models with the training dataset using class-balanced example selection, wherein training comprises training the one or more student classification models to predict data generated by the one or more teacher classification models; and
providing the one or more student classification models as an output.

24. The one or more non-transitory computer readable media of claim 23, wherein the operations further comprise:
obtaining an image;
processing the image with the one or more student classification models to generate one or more classifications; and
providing for display the one or more classifications, wherein the classifications comprise one or more objects recognized in the image.

25. The one or more non-transitory computer readable media of claim 23, wherein training the one or more teacher classification models and training the one or more student classification models comprises separately training a feature extractor and a network classifier for each of the one or more teacher classification models and each of the one or more student classification models.
